(19) United States
(12) Patent Application Publication
(10) Pub. No.: US 2007/0261280 A1
(43) Pub. Date: Nov. 15, 2007

(54) Portable folding sign apparatus

(76) Inventor: Maryam Rastegar, Studio City, CA (US)

Correspondence Address: EDWIN TARVER, 16830 Ventura Blvd., SUITE 360, Encino, CA, 91436, US

(21) Appl. No.: 11/880,796

(22) Filed: Jul. 23, 2007

Related U.S. Application Data
(63) Continuation-in-part of application No. 11/176,832, filed on Jul. 8, 2005.

(51) Int. Cl. G09F 13/00; G08B 13/00; G09F 15/00; G08B 21/00

(52) U.S. Cl. 40/541; 340/540; 340/572.1; 361/600; 40/610

(57) ABSTRACT

A collapsible sign apparatus comprising a flag structure with an adjustable hinge, announcement display means, a screen with LED display, a support structure, Radio Frequency Identification (RFID) tag for keeping track of the apparatus, a motion sensor for assisting a user to find the sign apparatus, a collapsible flyer box, a cover, and a case. The support structure comprises a frame and collapsible leg members connected to the frame with a hinge. The display means comprise alphanumeric cards and an LED display means, which are engaged to the support structure or the screen assembly using fasteners.

### CROSS-REFERENCE TO RELATED APPLICATION

This application is a Continuation-In-Part of application Ser. No. 11/176,832, filed on Jul. 8, 2005.

### FEDERALLY SPONSORED RESEARCH

Not Applicable

### SEQUENCE LISTING OR PROGRAM

Not Applicable

### STATEMENT REGARDING COPYRIGHTED MATERIAL

Portions of the disclosure of this patent document contain material that is subject to copyright protection. The copyright owner has no objection to the facsimile reproduction by anyone of the patent document or the patent disclosure as it appears in the Patent and Trademark Office file or records, but otherwise reserves all copyright rights whatsoever.

### BACKGROUND

The present invention relates to sign apparatuses commonly used in real estate advertisements and by street crews to communicate with public, and more particularly to portable and collapsible sign apparatus having tracking features.

Several sign apparatuses have been developed in the art. U.S. Pat. No. 5,467,076 to Ruocco discloses a realty sign lighting and display assembly having a vertical post and a horizontal cross-arm from which depends a display panel. The cross-arm is specially constructed to incorporate within it anti-theft and display components and components for powering the anti-theft display components. The cross-arm includes a solar panel, preferably at the top of the cross-arm, and a rechargeable battery connected to the solar panel. The battery powers one or more spot lights located in the bottom of the cross-arm and directed at the display panel below the cross-arm. An alarm connected to the battery prevents theft of the cross-arm. Preferably, the alarm includes a pendulum switch activatable by moving the cross-arm. The switch may be connected to a programmable coder. The cross-arm also includes a continuous advertising tape broadcast by a radio transmitter in the cross-arm. A door bearing a lock in the cross-arm provides access to the components in the cross-arm.

U.S. Pat. No. 6,668,474 to Winterton discloses a outdoor sign apparatus comprising a pair of horizontally spaced footings for a support base, a movable support frame that holds the sign, a plurality of stakes for mounting, and support elements. The support frame is supported by each of the footings and has a first position substantially perpendicular to the footings for display and a second position substantially parallel to the footings for transport. Support elements such as chains connect between the support frame and the footings to selectively hold the support frame vertically upright in the first position. The support elements can be disconnected to release and lower the support frame to the lowered position for transport. The stakes are driven downward into the ground at an outwardly extending angle relative to the vertically upright support frame and sign. To guide the stakes, each of the footings includes outwardly angled stake guides proximate opposite ends of each footing that slidably receive the stakes.

U.S. Pub. No. 20060185203 to Bittle discloses a portable illuminated real estate sign system consists of a carrying case, a sign, and a post. The illuminated sign is solar powered and is attached to a detachable post that has an anti-theft device. An accompanying bag is used for ease of transport and storage. The sign can be single- or double-sided, having a weatherproof casing, a plastic transparent front and back, and a hinged door to allow signage to be easily changed. Within the sign casing is a solar panel that collects solar energy to charge at least one rechargeable battery, energizing light sources to be turned on by a light sensor from dusk till dawn.

U.S. Pub. No. 20060016111 to Simmons discloses a real estate to go sign post that is a telescoping structure with three retractable and extendable supports. The signpost can be retracted to make it smaller than wooden posts for easy transportation. It can then be quickly installed and extended for immediate use. This signpost also has extra features such as a theft prevention locking system for the post and installed real estate signs, a document storage compartment for information sheets about the property being offered, and for business cards for the business of person selling or leasing the property. The sign post comes with a choice of three different mounting bases: the conventional base which can be installed in a hole in the ground, the sand or water-filled base which can be placed on a surface and filled with a sufficient amount of sand or water to support the structure, and a quick-install base with spikes that can be hammered into the ground.

The sign apparatus present invention is different from the above mentioned art in terms of its structure and construction, which make the sign apparatus quick and easy to install and collapse, easily visible, portable, and convenient.

Existing signs are heavy, bulky, fall apart, cause injury and difficult to read. Open house signs that are left on the street are susceptible to theft, damage or misplacement by competitors. It may be difficult for agents to keep track and collect all the signs they have posted. Existing signs does not have a special cover and case to protect it from damages and to prevent contamination from dust.

It is therefore an object of the present invention to provide a sign apparatus including a compact sign which can be folded, a cover so that it can be carried easily, and a case to keep related accessories together, including multiple signs, in a preferred embodiment five to ten signs per case, one compartment per sign. All signs and related accessories can be carried in one small compact case together.

A further object is to provide a sign apparatus that provides clear and neat announcement, assists in finding the signs easily, and prevents damage and misplacement of the signs. Using the present invention, street crews and real estate agents can present announcements which can be viewed and read even in a dark area and receive more attention from viewers. Other objects of the present invention will become better understood with reference to the appended Summary, Description, and Claims.

### SUMMARY

The present invention is a sign apparatus that mainly includes a collapsible signpost with illuminating, anti-theft and tracking features, a collapsible flyer box, a durable cover for signs, and a case for carrying related accessories such as signs and office supplies. The apparatus also includes alphanumerical cards, active RFID tag Radio Frequency Identification, LEDs Light Emitted Diodes and motion sensors.

Active RFID tags help in keeping track of the apparatus. The alphanumerical cards and LED announce an event or show the address more clearly compared to handwritten or printed announcement. The object of including LED is to increase visibility of the display information, to receive more attention from people who pass by, and to maintain visibility in the dark and evening hours. LED strips are light weight, easily assembled and require low power such as two AA size batteries or rechargeable batteries.

The object of including a motion sensor is to assist the user to find signs easily and to prevent theft or damage. The motion sensor is a detector which communicates with a user via mobile phone, computer, e-mail, beepers or alarm, keychain or hand held remote. The motion sensor activates a siren and flashing lights upon intrusion. Motion sensors can operate with a standard watch battery to monitor and register motion as well as sound. The motion sensor used in the present invention can be an outdoor waterproof type sensor which either battery-operated or photoelectric. Signals from the motion sensor are communicated to a user. The user can have access to a private code to turn the motion sensor on or off. Motion sensors that are currently available in the market and are used in medical field and athletic field, such as timing chips used by marathon runners that are attached to their shoes to track their location and timing on the marked course, can be used with the present invention.

### BRIEF DESCRIPTION OF THE FIGURES

FIG. 1 is an illustration of the sign apparatus in accordance with the present invention.

FIG. 1.1 is an illustration of the sign apparatus in a folded position.

FIG. 2 is an illustration of the finial.

FIG. 3 is an illustration of the flag structure.

FIG. 4 is an illustration of the hinge in folded condition.

FIG. 5 is an illustration of the hinge in straight condition.

FIG. 6 is an illustration of the frame.

FIG. 7 is an illustration of the first embodiment of the legs.

FIG. 8A is an illustration of the second embodiment of the legs.

FIG. 8B is an illustration of the second embodiment of the legs with dispersed ribs.

FIG. 9A is an illustration of the third embodiment of the legs.

FIG. 9B is an illustration of the members of the third embodiment of the legs in dispersed condition.

FIG. 10 is an illustration of a front view of the top cover.

FIG. 11 is an illustration of the alphanumeric card.

FIGS. 12A and 12B are illustrations of front and rear views of the motion sensor, respectively.

FIG. 13 is an illustration of the screen assembly.

FIG. 14 is an illustration of an LED strip.

FIGS. 15A and 15B are illustrations of front and rear views of the flyer box, respectively.

FIG. 16 is an illustration of the cover for the sign apparatus.

FIG. 17A is an illustration of the case in open condition.

FIG. 17B is an illustration of the case with the sealing means closed over the folded signs in the case.

FIG. 18A is an illustration of a front view of the case.

FIG. 18B is an illustration of a rear view of the case.

### FIGURES—REFERENCE NUMERALS

10 . . . Finial
11 . . . Decorative Top
12 . . . Stem
20 . . . Flag Structure
21 . . . Flag
22 . . . Rod
23 . . . Folding Edge of the Flag
24 . . . Slit
25A . . . Top End
25B . . . Bottom End
26 . . . Hole
28 . . . Hinge
29 . . . Leg
30 . . . Frame
31 . . . Bridge
32A . . . Support Wall
32B . . . Support Wall
33A . . . Leg
33B . . . Leg
34A . . . Joint Holder
34B . . . Joint Holder
35 . . . Knob
36 . . . Pole
37 . . . Foot Member
38 . . . Belt
39 . . . Washer
40 . . . Top Cover
41 . . . Top Side of the Top Cover
42A . . . Front Side of the Top Cover
42B . . . Back Side of the Top Cover
43A . . . Left Side of the Top Cover
43B . . . Right Side of the Top Cover
44A . . . Upper Folding Edge
44B . . . Lower Folding Edge
45 . . . Receptacle
46 . . . Card
47 . . . Groove
48 . . . LED
50 . . . Motion Sensor
51 . . . Front Side of the Motion Sensor
52 . . . Detector Light
53 . . . Switch
54 . . . Battery
55 . . . Bracket
56 . . . Column
60 . . . RFID
70 . . . Screen Assembly
71A . . . Top Pole of the Screen Assembly
71B . . . Bottom Pole of the Screen Assembly
72A . . . Cap in the Screen Assembly
72B . . . Cap in the Screen Assembly
73 . . . Pin
74 . . . Screen
75 . . . Spring
76A . . . Loop
76B . . . Loop
77A . . . Hook
77B . . . Hook
80 . . . Flyer Box
81 . . . Cap of the Flyer Box
82 . . . Snap Button
90 . . . Cover
91 . . . Plastic Bag
92 . . . Top End of the Cover
93 . . . Shoulder Strap
94 . . . Bottom End of the Cover
95 . . . Folding Edge at the Top End of the Cover
96 . . . Band
100 . . . Case
101 . . . Top Portion of the Case
102 . . . Bottom Portion of the Case
103 . . . Locking System
104 . . . Handle
105 . . . Wheel
106 . . . Peg
107 . . . Pull-out Handle
108 . . . Belt Strap
109 . . . Compartment
110 . . . Sealing Means, including a plastic sealable pouch
111 . . . Folder Pockets
112 . . . Business Card Pocket
114 . . . General Compartments
115 . . . Plastic ID Sheets

### DETAILED DESCRIPTION

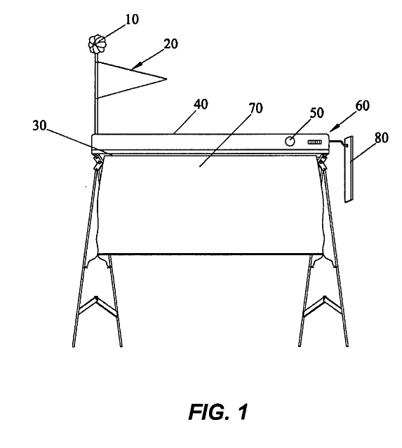

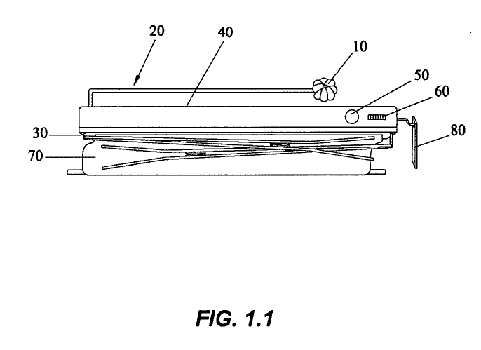

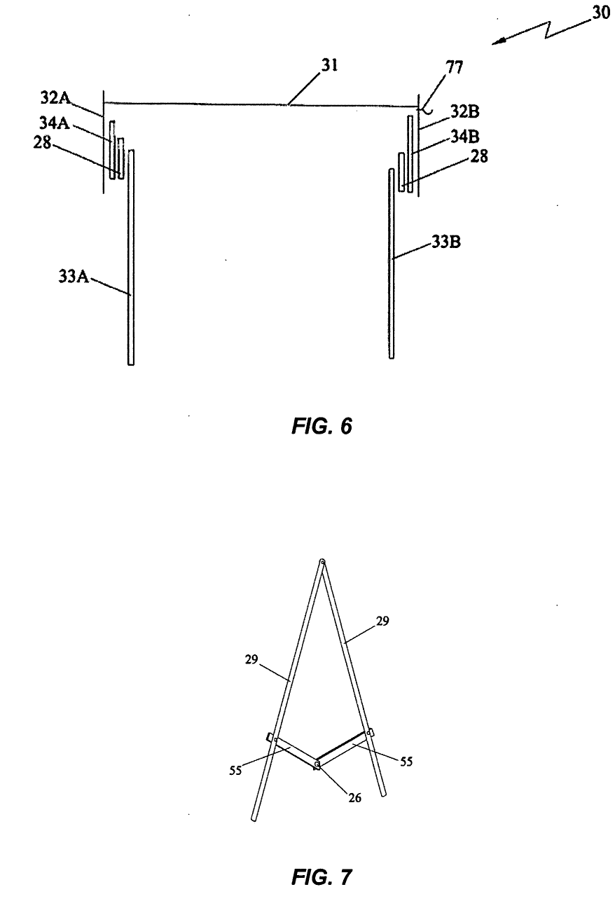

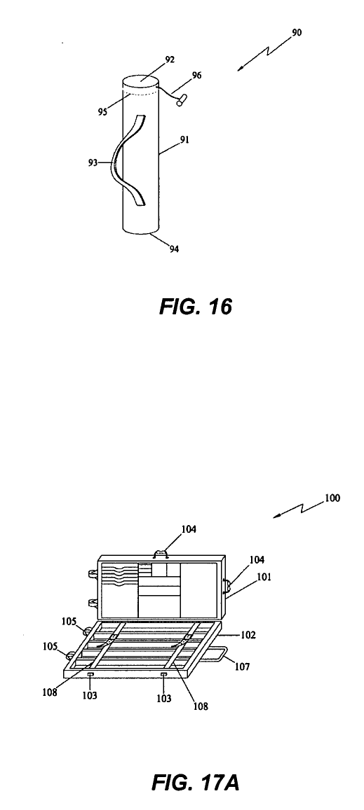

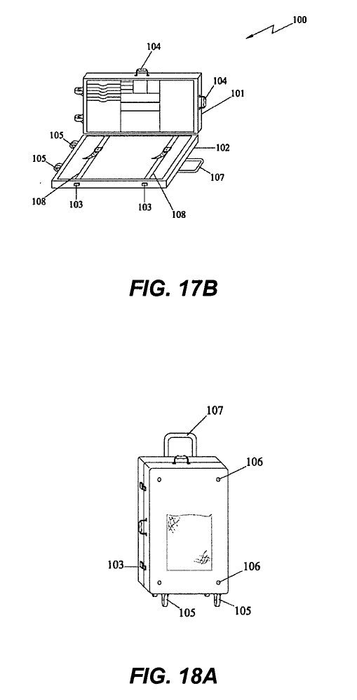

Referring to the drawings, preferred embodiments of the present invention are illustrated in FIGS. 1 through 19B. Referring to FIG. 1, the sign apparatus of the present invention includes a finial 10, a flag structure 20, a frame 30, a top cover 40, a motion sensor 50, an RFID 60, a screen assembly 70, a flyer box 80. The apparatus also includes a cover 90 and a case 100, as shown in FIGS. 16 and 17.

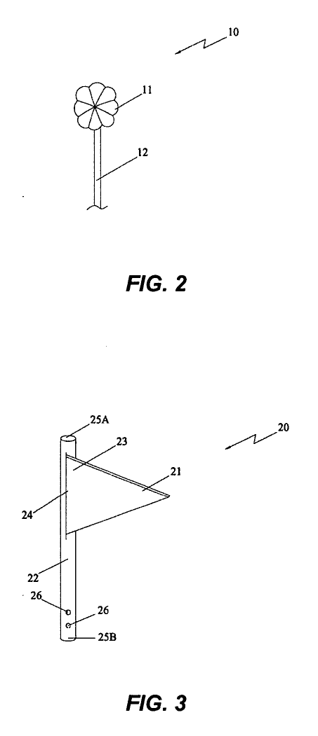

Referring to FIG. 2, the finial 10 includes a decorative top 11 on top of a stem 12. The decorative top can be a light, a star, a flower, figurine, or any object that can be selected by the user. A light is preferred because it receives more attention and makes it easy to find the sign in a dark area. The stem 12 is cylindrical. The finial is made of plastic.

Referring to FIG. 3, the flag structure 20 includes a flag 21 with a folding edge 23, a rod 22, a slit 24 on the rod, hole 26. The rod 22 is a plastic cylinder with open ends 25A and 25B. The bottom end of the stem 12 fits inside the top end 25A and of the rod 22. Flag 21 is made of fabric or soft plastic which is triangular in shape. The flag is folded along the folding edge 23 that goes inside the slit 24. The slit 24 extends from top to middle of the rod 22. The folding edge 23 rests inside the slit 24 and prevents the flag from coming out. The flag 21 can be blank or can include announcements such as name, telephone number and/or company name. The flag can be made in different colors.

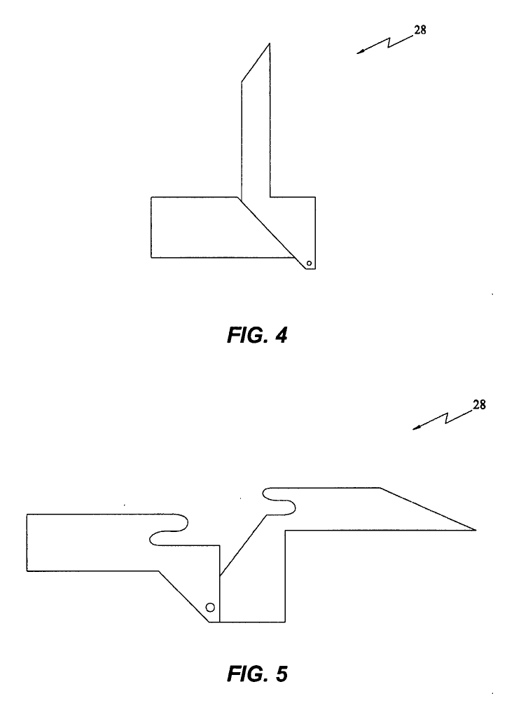

Referring to FIGS. 3 through 5, a hinge 28 is connected to the flag and leg structure to enable pivoting movement. The hinge 28 is connected to the rod 22 using pins through the holes 26. The hinge 28 is “L” shape when it is opened and is adapted to stand steadily at this position. In this position, the flag structure 20 stays in an upright vertical position. FIG. 4 is an illustration the hinge's 28 position when the flag and leg structures 20 are folded down to lie down on the top cover 40, and inside the top cover 40. The hinge 28 that is currently in the market and used in kitchen cabinet industry can be employed in the present invention.

Referring to FIGS. 1 through 6, the frame 30 includes a bridge 31, support walls 32A and 32B, hinges 28, legs 33, and joint holders 34A and 34B. The bridge 31 is a stationary part which attaches to the joint holders 34A and 34B and the support walls 32A and 32B by pins. The bridge 31 is a plastic or metal cylinder tube or square tube. The bridge is under the top cover 40 and acts as a seat for the top cover 40. Under the bridge 31 is a seat for the screen 70 and the legs 33. The motion sensor 50 and the RFID tag 60 can be placed over or under the bridge 31. The legs 33 are connected to the joint holders and the supporting walls by hinges 28. The hinges 28 attach to the joint holders 34 at different heights, preferably, the left side is higher than right side so the legs sit over each other and fold properly. The legs 33 are cylindrical and are made of durable hard plastic or metal with different colors. The left leg is shorter than the right leg, because the hinge connected to the left joint holder one inch higher.

The bottom end 25B of the rod 22 stands over the bridge 31 and joint holder 34A. The lower part of the rod 22 is in connection with the top cover 40, the top end of the bridge 31, and support wall 32 by the hinge 28. The apparatus can include two flag structures 20, with a second flag structure parallel to the first flag structure and placed on the other end of the bridge 31.

The support walls 32A and 32B are rectangular flat shaped walls which connect and support the bridge 31, the joint holders 34A and 34B, and the hinges 28. They are made of durable soft plastic or light weight metal. There are holes on the support walls, joint holders and hinges for connection using pins. The joint holders 34A and 34B are right angular boxes which are made of metal, hard plastic or wood. The joint holders 34A and 34B are placed under the bridge 31, next to the supporting walls 32A and 32B, and support the bridge 31, the hinges 28, legs 33, and screen 70. In an alternate embodiment, the support wall and the joint holder 34 can be one piece.

Referring to FIGS. 7 through 9B, the legs comprise three embodiments, namely, standard legs, umbrella legs, and ibis legs. All these legs have a hole on top for connection to the hinges with pins. Each standard leg comprises two rod members 33 connected at their upper ends. Two brackets 55 attached to the middle of rod members 33 facilitate in keeping the rod members apart at a certain distance. There is a hole 26 at intersection of the brackets, which is also the site of a hook to hold the screen in a down position.

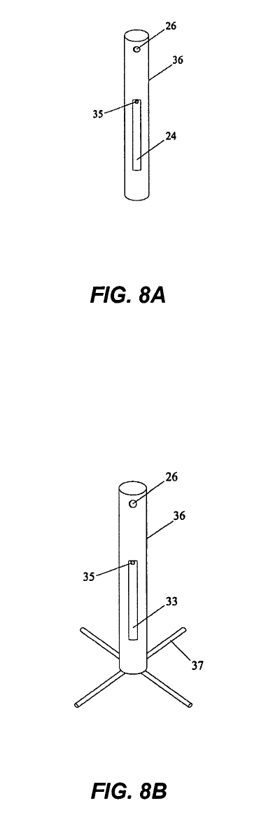

Referring to FIGS. 8A and 8B, the umbrella legs include a pole 36, foot members 37, and a knob 35. The mechanism of this embodiment is similar to an umbrella mechanism. The umbrella leg looks like up side down umbrella with four to six foot members 37 when it is open. When the knob 35 is pushed, the ribs pop out and stand on the floor. The length of the ribs is half of the size of the pole. The pole is cylindrical in shape and has a slit 24 on its lower part. The knob 35 moves inside the slit 24 and is in connection with the end of the foot members 37.

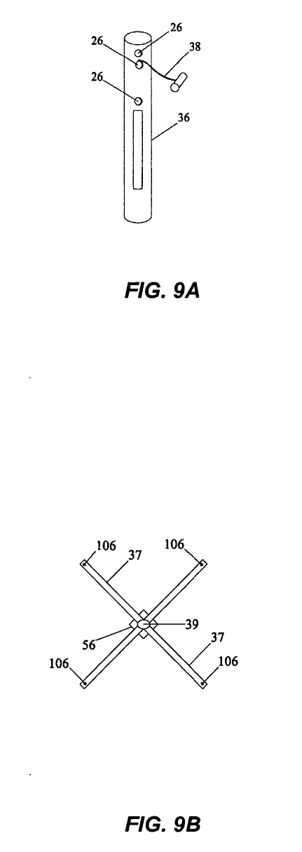

Referring to FIGS. 9A and 9B, the ibis legs include a pole 36, a column 56, and four foot members 37. The pole is a cylinder plastic or metal with a knob 35. The column 56 is located inside of the pole. Four to six foot members are attached via a hinge to the bottom of the column. The height of column is half of the pole. A washer 39 is located over the hinges on the bottom of the column to prevent the foot members 37 from moving inwards. When the knob is pushed, the foot members 37 come out of the pole and spread on the floor horizontally. The outer ends of the foot members include a peg that touches the floor. The pole has a slit 24 on its lower part, which lets the knob 35 move up and down to facilitate opening of the foot members 37. The pole has three holes. The top hole is for connection to the hinge 28, the middle hole is a passage for a belt 38, and the bottom hole is for a hook of the screen 77 when the easy sign is in the open position. The middle of the belt 38 attaches to the end of the knob 35, inside the pole, and the two ends of belt come out of the hole. In case of a problem with the knob 35, the belt 38 can be used to pulls the foot members 37 inside the pole. The end of the belt 38 is tied to prevent if from going inside the pole.

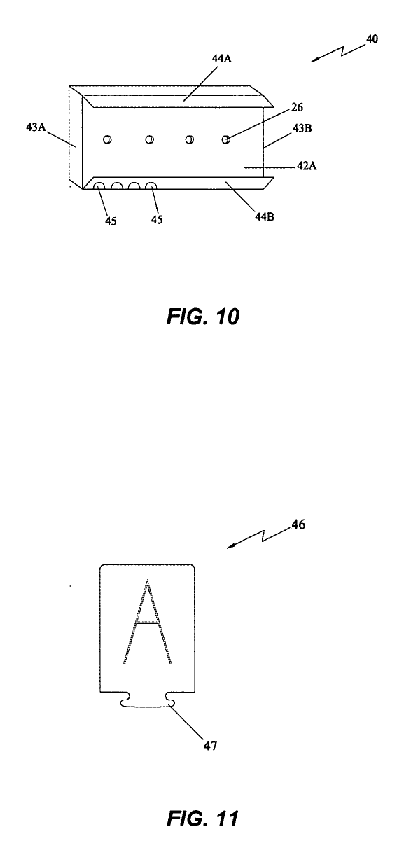

Referring to FIGS. 10 and 11, the top cover 40 is similar to a rectangular box without a lid, including a top side 41, front and back sides 42A and 42B, and left and right sides 43A and 43B. The motion sensor 50 and RFID tag 60 are placed on top of or under the top side 41 or front and back sides 42A and 42B. The RFID 60 is installed or buried inside of the top, front or back sides of the top cover. Users can then track and monitor the apparatus 10. The top cover is located on the top of bridge 31. It can be of any color and made of strong durable plastic. The front and back sides 42A and 42B provide a horizontal panel which is a site for alphanumerical cards 46 or LED 48. The front and back sides have folding edges 44 and receptacles 45 inside of the folding edge 44. The receptacles divide inside the folding edge to provide space for letters and numbers to address an announcement. In other embodiments, the front and back sides include holes or Velcro to hold the alphanumeric cards. In another embodiment, a string is placed with many bids inside of the folding edge instead of dents to hold the ends of the alphanumerical cards. Each alphanumeric card 46 has a groove 47 on the bottom which is made of washable hard plastic in different sizes, colors and shapes. The groove 47 clicks to the receptacle 45. The cards 46 card include Velcro, magnet or pin to stick or click to the front 42A and back 42B sides of the top cover.

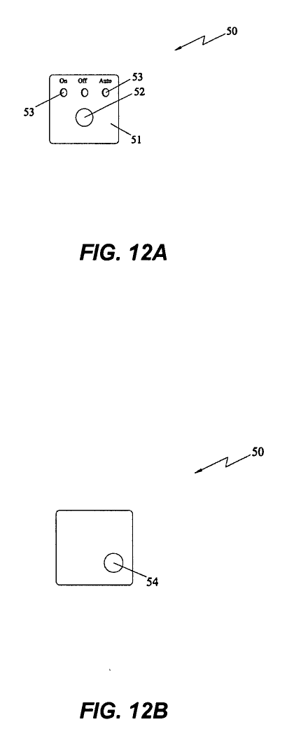

Referring to FIGS. 12A and 12B, the motion sensor 50 includes a detector light 52 located on its front side 51 and it can be adapted to communicate with a user via electronic devices such as mobile phone, computer, e-mail, beep or alarm, keychain, or hand held transmitter remote. It is battery-operated or photoelectric. The battery can be a standard watch battery 54. There is an on/off/auto switch 53 on top or behind the motion sensor. The motion sensor monitors and registers motion as well as sound. The motion sensor is outdoor waterproof type and it is installed on the front or back sides of the top cover. The motion sensor activates a siren and flashing lights when an intruder approaches. Signals from the motion sensor are transmitted, and a sequence of events is performed which users can customize. Users can have access to the private code to turn the motion sensor on or off.

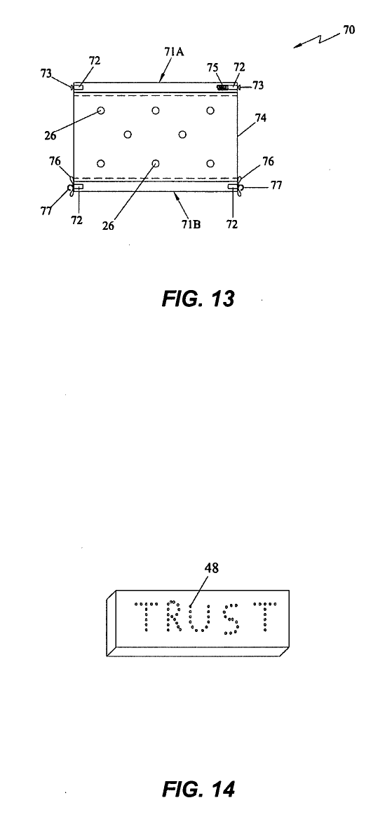

Referring to FIG. 13, the screen assembly 70 includes a screen 74, top and bottom poles 71A and 71B, caps 72A and 72B, pins 73, loops 76A and 76B, and hooks 77A and 77B. The screen is rolling screen which is used to cover window and it is available on the market. In the present invention the rolling screen 74 used with small changes, touch and different fabric. The poles 71A and 71B are cylindrical and attached to the screen 74. The poles 71A and 71B can be made of wood, plastic or metal. The caps 72A and 72B include the pins 73 which attach to the interior wall of the joint holder. The pins allow the screen to roll up and down. The caps 72A and 72B fit in the mouth of the poles. The top pole 71A is stationary and located between two joint holders, but it can be removed for changing the screen. There is a spring 75 inside right corner of the top pole 71A. The spring is used to release the screen and can be assisted to place the screen.

The bottom pole 71B rests on the bottom of the screen 74 which has two hooks 77A and 77B or magnets on each end. The hooks 77A and 77B or magnets attach to the hole in the bracket of the leg members located between the legs to prevent closing of the screen. The bottom pole is heavy enough to hold the screen down, to roll the screen down, to keep distance between two legs and to keep the screen straight and unfolded position when the portable folding sign is used. There are two loops 76A and 76B which attach to the end of the bottom pole. The loops are placed around legs which go up and down when closing and opening the screen, it prevents of over extension of legs. There are two types of waterproof screen can be used; the rolling screen and horizontal screen like horizontal drape. The rolling screen 74 made of washable thick flexible fabric or plastic can have words and arrows for indicating the information and directions to an event on each side of the screen separately. Fabric should be thick enough so that the words printed on the opposite side cannot be seen. The top and bottom of the screen 74 are connected to the top and the bottom poles, respectively.

The screen 74 has several vent holes 79 to let air passes through and prevents the sign apparatus from falling during windy weather. The screen can be made of LED strips. LEDs 48 are arranged in alphanumeric characters to address an announcement, as seen in FIG. 14. In another embodiment, the horizontal screen is made of four equal parts which go up and down like a horizontal drape. Each parts looks like the top cover, which has a folded edge for alphanumerical cards. It is a preferred option, especially in restaurants, when more space is required for announcement. The rolling screen and the horizontal screen are rectangular.

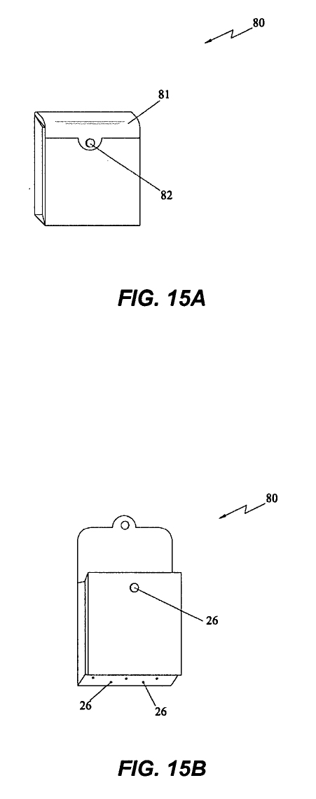

Referring to FIGS. 15A and 15B, the collapsible flyer box 80 is a folding pocket which made of thick heavy clear plastic to carry many flyers. The box has a hole 26 on its back for hanging it to a hook 77 of the top cover. The flyer box 80 also has holes 26 at its bottom for rain water draining. The flyer box 80 also includes a cap 81 which can be secured to cover the flyers with a snap button 82.

Referring to FIG. 1.1, the legs 29 or 33 fold inside of the top cover and sit on the screen parallel to bridge in the folding position. To open the apparatus, the legs and the flag structure are unfolded by pivoting, the screen is pulled down and hooks are engaged with the holes on the legs. The loops of the screen control the maximum extension when the first embodiment of the legs is used.

Referring to FIG. 16, the cover 90 includes a clear thick plastic bag 91, a shoulder strap 93, and a band 96. The bag is open at top 92 and closed at its bottom 94, and a folding edge 95 providing a drawstring for the band to close the cover and carry the sign to prevent damage, injury and contamination.

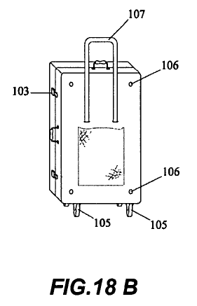

Referring to FIGS. 17, 18A and 18B, the case 100 has a rectangular shape with top 101 and bottom 102 portions, and includes a locking system 103, a pair of handles 104, wheels 105, pegs 106, and a pull out handle 107. The case is made of durable plastic, wood or metal. The locking system is located on the front side. The top and bottom portions include the handle 104. A Velcro strap is used to secure the handles 104 of the top and bottom portions together. The case 100 includes clear outside plastic pockets 115 for labels. The pegs 106 are located at the four corners of the top and bottom surface of the case. The pull out handle 107 is used to pull the case on the wheels. The inside of the case has bottom and top sides. The bottom side has individual compartments for the folded sign apparatus and includes belt straps 108. The case holds five to ten signs, office supplies, tools, some personal items and other related accessories. The case helps in organizing things and saves time for users, and protects signs from damage. There is a clear large zip lock bag 110 on the middle for extra clothes like a coat or jacket which it separates top from bottom. The top side is constructed for office supplies or for tools for the road work crews. Items such as folders, pens, instruction discs or tapes, business cards, calculator, ID cards or money bills can be held in the case.

All features disclosed in this specification, including any accompanying claims, abstract, and drawings, may be replaced by alternative features serving the same, equivalent or similar purpose, unless expressly stated otherwise. Thus, unless expressly stated otherwise, each feature disclosed is one example only of a generic series of equivalent or similar features.

Any element in a claim that does not explicitly state “means for” performing a specified function, or “step for” performing a specific function, is not to be interpreted as a “means” or “step” clause as specified in 35 U.S.C. § 112, paragraph 6. In particular, the use of “step of” in the claims herein is not intended to invoke the provisions of 35 U.S.C. § 112, paragraph 6.

Although preferred embodiments of the present invention have been shown and described, various modifications and substitutions may be made thereto without departing from the spirit and scope of the invention. Accordingly, it is to be understood that the present invention has been described by way of illustration and not limitation.

What is claimed is:

1. A portable and collapsible sign apparatus, comprising:
(a) at least one collapsible flag structure;
(b) announcement display means;
(c) at least one collapsible screen assembly;
(d) a collapsible support structure for the at least one flag structure and the at least one screen assembly;
(e) a means for keeping track of the apparatus;
(f) a means for assisting a user to find the sign apparatus;
(g) a cover for the collapsed apparatus;
(h) a case;
(i) a collapsible flyer box;
(j) fastening means; and
(k) an illuminated announcement display means;

2. The sign apparatus of claim 1, wherein the flag structure comprises a pole, a collapsible flag attached to the pole and a finial attached on top of the poles, the flag the finial are detachable from the pole.

3. The sign apparatus of claim 2, wherein the finial has an illuminating means.

4. The sign apparatus of claim 2, wherein the flag is attached to the pole using sliding engagement mechanism, wherein the flag structure is attached to the support structure with a lockable hinge.

5. The sign apparatus of claim 1, wherein the flag structure is attached to the support structure with a lockable hinge.

6. The sign apparatus of claim 1, wherein the announcement display means comprises alphanumeric cards, including LEDs, a motion sensor and an RFID tag which are engaged to the support structure or the screen assembly using fastening means.

7. The sign apparatus of claim 1, wherein the fastening means comprise snapping mechanism, hook and loop fastening system, hinge, and magnetic fastening systems.

8. The sign apparatus of claim 1, wherein the at least one collapsible screen assembly comprises at least one screen and a means to secure the at least one screen to the support structure.

9. The sign apparatus of claim 8, wherein the at least one screen is a rolling screen and is made of flexible material and can be detached and replaced easily and is compact.

10. The sign apparatus of claim 8, wherein the illuminated display means comprises Light Emitting Diode (LED) strips attached to the screen, with the LEDs arranged in the form of LED alphanumeric characters and a variety of designs to address an announcement, including giving directions.

11. The sign apparatus of claim 8, wherein the screen comprises holes for reducing wind resistance.

12. The sign apparatus of claim 1, wherein the illuminated display means comprises Light Emitting Diode (LED) strips attached to the screen assembly, with the LEDs arranged in the form of alphanumeric characters and a variety of designs to address an announcement, including giving information.

13. The sign apparatus of claim 1, wherein the support structure comprises a frame and collapsible leg members connected to the frame with hinge mechanisms, including lockable hinge mechanisms.

14. The sign apparatus of claim 12, wherein the at least one flag structure is connected to the frame with a hinge and the screen assembly is connected to the frame.

15. The sign apparatus of claim 13, wherein the at least one flag structure is connected to a corner of the frame.

16. The sign apparatus of claim 13, wherein the apparatus comprises a pair of the flag structures that are connected to opposite sides of the frame.

17. The sign apparatus of claim 12, wherein the screen assembly comprises a screen that is held in place by connecting it with the frame and the leg members.

18. The sign apparatus of claim 12, wherein the leg members comprise two pairs of rod members, the rod members in each pair are connected at the top so that they can be moved apart to support the apparatus on the ground, and are lockable.

19. The sign apparatus of claim 18, wherein each pair of the rod members include a means to maintain distance between their bottom ends when supporting the apparatus.

20. The sign apparatus of claim 12, wherein the leg members comprise a pair poles and a plurality of ribs that are configured such that they are adapted to be held inside the pole when the apparatus is in collapsed and come out of the pole and spread on the ground when the apparatus is to be supported on the ground.

21. The sign apparatus of claim 19, wherein a spring loaded, push button activated mechanism, similar to that of an umbrella mechanism, is employed for the foot members.

22. The sign apparatus of claim 1, wherein the means for assisting a user to find the sign apparatus comprises a motion sensor capable of communicating to a user.

23. The sign apparatus of claim 22, wherein the motion sensor is capable of communicating via mobile phone, computer, e-mail, beep or alarm, keychain, or hand held transmitter remote.

24. The sign apparatus of claim 22, wherein the motion sensor also comprises an illuminating means, including a light.

25. The sign apparatus of claim 1, wherein the apparatus further comprises a collapsible flyer box adapted to be secured to the apparatus, which also fits in the apparatus case.

26. The sign apparatus of claim 1, wherein the cover comprises a plastic bag, a shoulder strap and a means for closing the plastic bag comprising drawstrings to prevent injury, contamination and damage.

27. The sign apparatus of claim 1, wherein the case comprises a locking system, at least one handle, a pull-out handle, wheels, and means to hold signs, office supplies, and other accessories together, and moves on wheels to prevent loss, damage and injury to a user.

28. The sign apparatus of claim 1, wherein the means for keeping track of the apparatus comprises an active RFID tag.

29. The apparatus of claim 6, wherein the top cover holds the legs and screen of the apparatus in a folded position.
